(19) United States
(12) Patent Application Publication
(10) Pub. No.: US 2009/0063466 A1
(43) Pub. Date: Mar. 5, 2009

(54) Resource selector, including for use in handheld devices

(75) Inventors: Yanfei Xu, Shanghai (CN); Xiao Xe, Shanghai (CN); Arun K. Nanda, Sammamish, WA (US); Kim Cameron, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/897,585

(22) Filed: Aug. 31, 2007

(51) Int. Cl. G06F 17/30

(52) U.S. Cl. 707/5; 707/E17.017

(57) ABSTRACT

Described is a technology by which a resource selector traverses a hierarchical storage structure to enumerate its resources and provide a flat list of corresponding items. The user interacts with the flat list to select an item. The resource selector is particularly beneficial when incorporated into a handheld computing device. The resource selector may use a filtering criterion associated with an application program, e.g., the hierarchical storage may correspond to a file system, with the file extension (type) being the filtering criterion. A trigger coupled to the resource selector triggers the resource selector, in which the trigger may be incorporated into the application program, or may comprise an application-independent (e.g., operating system) component that knows which application program currently has focus and triggers the resource selector for that application.

### BACKGROUND

In a device application, it is generally inconvenient for a user to find and access a resource by navigating through the levels of a hierarchical storage structure. A user often may need to browse up and down through the storage hierarchy several times before finding the resource, particularly if the user cannot remember the exact location.

By way of example, when attempting to locate a file in a file system, it is a difficult task to locate a target file under a deep level of folders. The deeper the file in the hierarchy, the more difficult in general it is to find that file. The problem is compounded on handheld devices such as mobile telephones, because of their small screen size and key panel.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a resource selector traverses a hierarchical storage to enumerate resource items corresponding to the requested set of resources, and returns a result set comprising one or more resource items arranged as a flat list. The enumeration is in response to a request associated with an application program, which is not a user-initiated search program. The resource selector is particularly beneficial when incorporated into a handheld computing device.

In one aspect, the request is associated with a type of resource, which is used by the resource selector as a filtering criterion. For example, the hierarchical storage may correspond to a file system, with the type of resource corresponding to a file extension. The criterion may be provided as a parameter accompanying the request, or may be registered in association with the application program.

In one implementation, a trigger coupled to the resource selector triggers the resource selector when activated to traverse the hierarchical storage to enumerate resources and return the result set as the flat list. The trigger may be incorporated into an application program, or may comprise an application-independent (e.g., operating system) component that knows which application program currently has focus and triggers the resource selector for that application.

In one aspect, resource items associated with an application program enumerated, in which the resource items representing resources arranged in a hierarchy. A flat list of the resource items is presented for user interaction therewith, including for selection of at least one resource item for access by the application program. For example, a candidate item may be visibly indicated (e.g., highlighted) for selection, with the user navigating to choose the candidate item prior to selection. A path corresponding to a position in the hierarchy of the candidate item may be shown to assist the user in the selection process.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example resource selector for locating resources without user search or navigation of a hierarchical storage structure.

FIG. 2 is a representation of locating resources comprising files via a resource selector.

FIG. 3 is a flow diagram representing example steps taken to return a result set comprising a flat list of resources maintained in a hierarchical storage structure.

FIG. 4 shows an illustrative example of a computing and communication device into which various aspects of the present invention may be incorporated.

### DETAILED DESCRIPTION

Various aspects of the technology described herein are generally directed towards a resource selector that provides a straightforward and efficient way for a user to locate and select resources that are maintained under a hierarchical storage structure. As will be understood, this is especially valuable for handheld device users where navigation is typically more difficult than with a mouse and full-sized display. However, the advantages that arise from the technology described herein are not limited to any particular computing and/or storage device, but instead may provide benefits with any computing and/or storage device, including those having a conventional mouse, a touch panel, a pointing device and so forth.

Thus, while various examples herein are primarily described with handheld computing devices such as mobile telephones, the technology herein is not limited to any type of device. Further, while the examples are directed towards a file system as the hierarchical structure, any hierarchical arrangement of resources may benefit from the technology described herein, such as a network storage mechanism, taxonomy, hardware resources, system services, and so forth. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and resource storage in general.

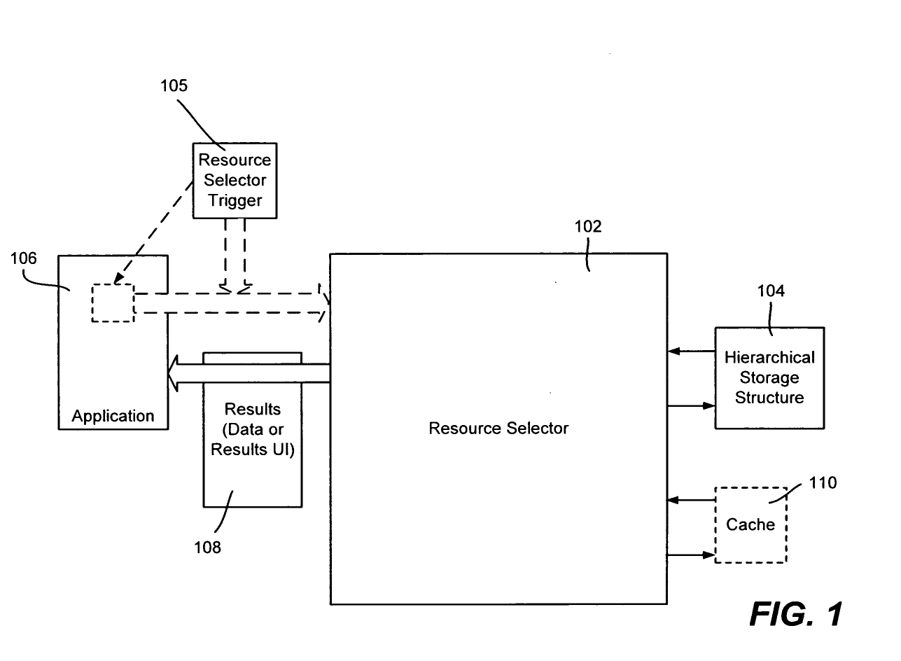

Turning to FIG. 1, there is shown a resource selector 102 that from the perspective of the user, bypasses the need to navigate a hierarchical storage structure 104 to locate a resource. Moreover, the user does not have to actively initiate a search to locate the resources, e.g., does not have to specify search terms, search scope and/or the like.

Instead, when the resource selector is triggered when the user activates a trigger 105, the resource selector 102 automatically traverses the hierarchical storage structure 104 to provide corresponding results 108, in the form of a set of desired resources in a flat view for users to directly select a resource. The set of resources presented to a user may be optionally filtered by some criteria, e.g. by file extensions in the case of file resources, and also may be limited to a certain scope, such as a particular storage volume. Note however that the user need not specify the filtering criteria and or scope.

By way of example, an application program 106 can be associated with an extension set of one or more file extensions, or can provide the extension set as a parameter. When invoked, the resource selector 102 will traverse the structure 104 and return only those files having an appropriate extension, without the user having to specify the extension set. Scope, sorting and/or grouping criteria can be automatically provided in a similar fashion, e.g., by a predefined association or as part of a parameter set.

As represented in FIG. 1 and as can be readily appreciated, the trigger 105 may be built into an application program 106, such as in the form of an icon, button and so forth that when actuated calls an API or the like to activate the resource selector 102. Alternatively, the trigger 107 may be a shared resource, such as an operating system component that when triggered, activates the resource selector 102 with respect to whichever application program currently has focus. In FIG. 1, the trigger 105 is alternatively shown as being a separate component or incorporated into the application program (via the dashed box therein), although it is feasible to have both and/or different trigger mechanisms.

In one alternative, optional implementation, the resource selector may be associated with a cache 110 that may maintain one or more sets of resources for rapid access. For example, if an application program requests the same set of resources and the results are still valid in the cache 110, e.g., the file system contents have not changed, there is no need to again traverse the hierarchical storage structure 104 to obtain the results. Note that the cache 110 is represented in FIG. 1 by a dashed box to indicate that such a component is optional.

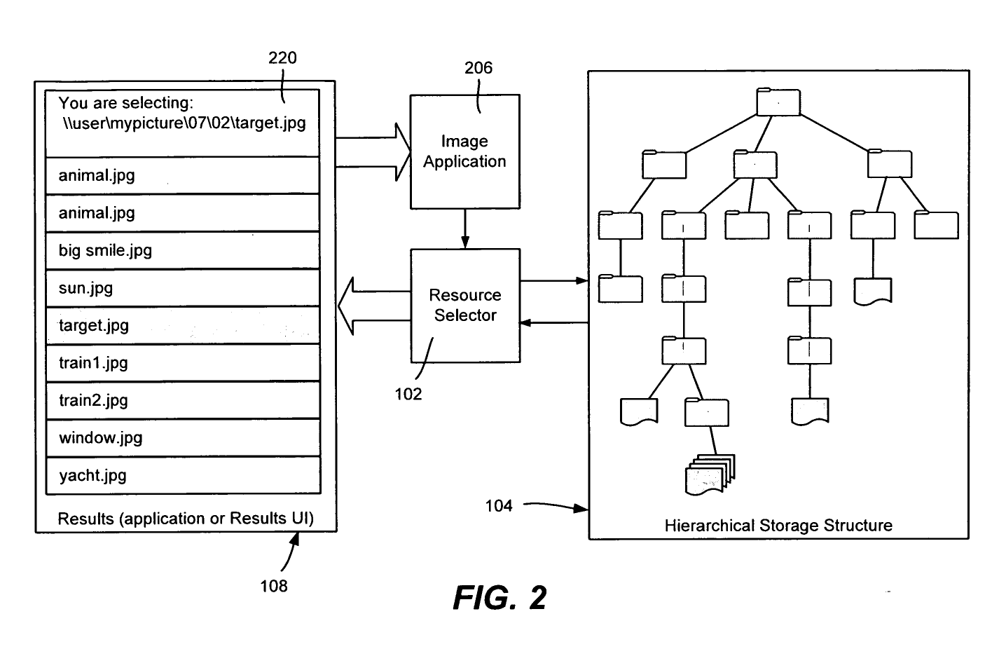

FIG. 2 shows an example result set that is returned when an image-related application program 206 is triggered by the user to provide a flat list of resources to select from among matching (*.jpg) selection candidates. For example, the application or operating system may provide the user with an icon, key combination or the like which when actuated communicates with the resource selector 102 to provide the flat list of corresponding results. In the example of FIG. 2, the image application program 206 or operating system (which knows that the image application 206 is in focus) specifies to the resource selector that *.jpg files are to be returned, such as by providing a parameter set to the resource selector 102, or by prior registration that associates that application (or application type) with that resource type.

In turn, without the user actively requesting a search for such file types, the resource selector 102 recursively traverses the hierarchical storage structure 104 and locates the matching files, that is, enumerates and returns the .jpg files in this example. Note that in a pre-registration process, the user may have previously specified “.jpg” as being associated with this application, but this is not the same as an active, user-initiated search. The resource selector 102 returns the results to the application 206, such as individually to build up a list of resource items as they are found, or as a whole after the traversal is complete. Note that rather than have each application provide its own user interface to present the list to the user for interactive selection, there may be provided an intermediate user interface component that handles the presentation of the results to the user and the user interaction, to then provide the application with a selection result. In FIG. 2, the results block labeled 108 represents the application program's user interface and/or an independent, intermediate result set user interface.

Thus, instead of requiring user to browse the hierarchy 104, the resource selector 102 processes resources recursively in the hierarchy 104 (according to some filtering, sorting and/or grouping criterion as appropriate), and provides the result set 108 in a flat list. As represented in the display area 220, as the user browses the list for selecting an item, the full hierarchy path may be shown to help user identify the resource, e.g., in FIG. 2 “target.jpg” is currently highlighted for possible selection, whereby the path “\\user\mypicture\07\02\target.jpg” is displayed in the area 220. Note that displaying the full path may be particularly beneficial when different folders contain different files with the same file name, e.g., “animal.jpga” was found in two folder locations, whereby the full path may help the user distinguish between them. Optionally, by inputting (e.g., typing) the first few characters of a resource's name, the user can navigate the list to quickly move to a desired resource.

As can be readily appreciated, in most applications, with filtering criterion the number of resources to present is usually reasonable to list for viewing on a device screen, (with some scrolling if necessary), and is thus far more convenient to locate a resource when compared to hierarchical browsing. This technology is thus especially valuable to handheld device users.

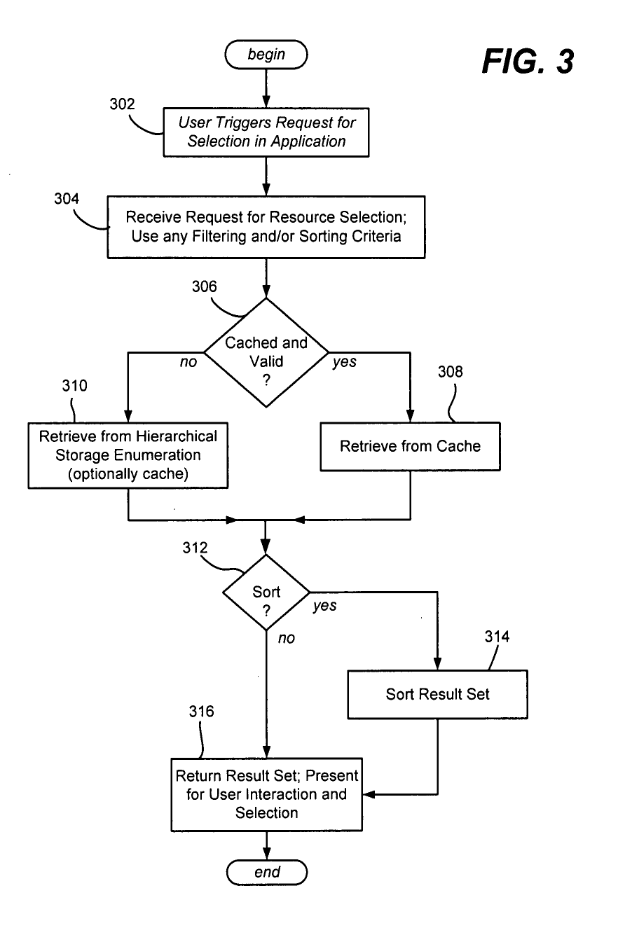

Turning to the flow diagram of FIG. 3, example steps in the general operation are described with reference to a file system as the hierarchical storage structure 104; most applications program use only files of certain selected types (i.e., files with a specified extension). When triggered by the user as represented via step 302, the trigger (application program or operating system component) communicates with the resource selector and provides its desired file type or types as a filtering criterion or criteria. Note that in an application program, this trigger may correspond to the application program's conventional “Open” request, (in which event the user may be given a secondary option to view different file types), or may be by a special “resource selector” request (whereby the “Open” request may provide conventional hierarchical browsing).

Step 304 represents receiving the request at the resource selector 102. As mentioned above, the filtering criterion may be provided as a parameter set, or may be pre-registered so that the filtering criterion is automatically associated with the requesting application program or the application program currently in focus. Note that other result set criteria may be provided, such as for sorting results (e.g., most-frequently accessed, most-recently accessed, by date, by size, by author and so forth), for scope, and/or for grouping results in some way, such as by file types instead of alphabetical based on file name. As can be seen in the example of FIG. 2, sorting is alphabetical. Another criterion can specify which item of the result set to initially highlight, e.g., list the resource items alphabetically but initially highlight the most-recently accessed item within that alphabetic list for possible selection.

Step 306 represents an optional cache checking step as described above, which if implemented can avoids needing to re-traverse the hierarchical storage by retrieving cached results (step 308) if the result set is previously cached and known to be valid. Otherwise, at step 310 the resource selector uses the filtering criterion, enumerates the resource (e.g., files) recursively in the specified location on the file system according to the selected types, and lists the found files in a flat list result set that is not organized hierarchically (e.g., as folders). The resource selector may also cache the enumerated items for possible later access.

Step 312 represents further processing of the located resource items, which in this example is sorting, but may also (or instead) include grouping, initial highlighting of a resource item, and so forth as described above. If in this example sorting is required, sorting is performed at step 314 before returning the result set at step 316. (In one implementation, alphabetic sorting is performed by default if no other sorting criterion is provided.) Note that in this example, the sorting (or other processing) occurs after any enumeration or optional cache retrieval, so that enumeration can retrieve resource items in any order, or the cache can maintain the list in any manner.

### Exemplary Operating Environment

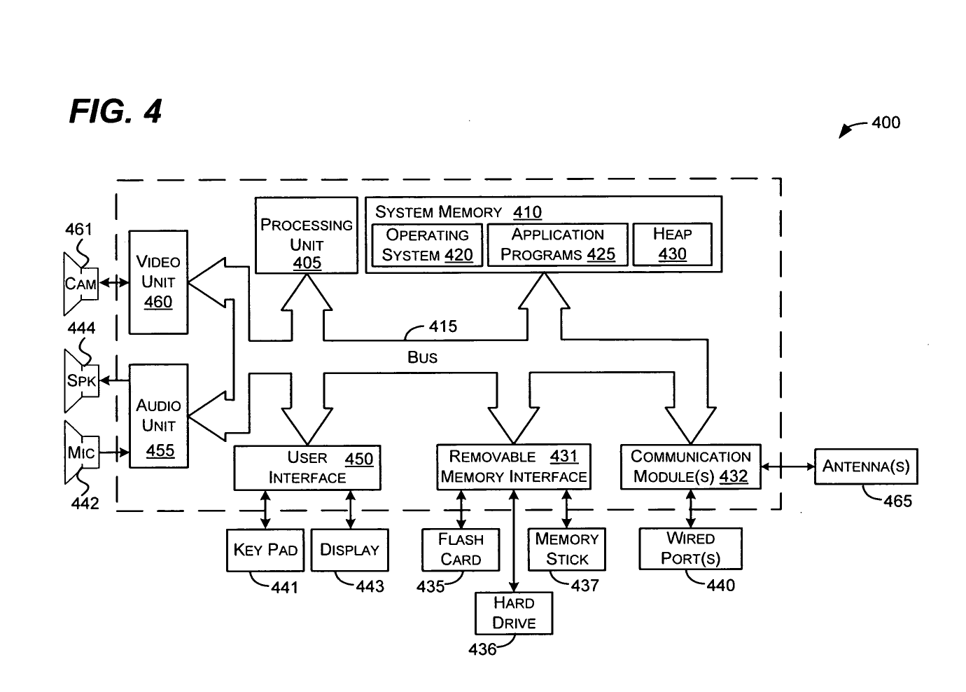

FIG. 4 illustrates an example of a suitable mobile device 400 on which aspects of the subject matter described herein may be implemented. The mobile device 400 is only one example of a device and is not intended to suggest any limitation as to the scope of use or functionality of aspects of the subject matter described herein. Neither should the mobile device 400 be interpreted as having any dependency or requirement relating to any one or combination of components illustrated in the exemplary mobile device 400.

With reference to FIG. 4, an exemplary device for implementing aspects of the subject matter described herein includes a mobile device 400. In some embodiments, the mobile device 400 comprises a cell phone, a handheld device that allows voice communications with others, some other voice communications device, or the like. In these embodiments, the mobile device 400 may be equipped with a camera for taking pictures, although this may not be required in other embodiments. In other embodiments, the mobile device 400 comprises a personal digital assistant (PDA), hand-held gaming device, notebook computer, printer, appliance including a set-top, media center, or other appliance, other mobile devices, or the like. In yet other embodiments, the mobile device 400 may comprise devices that are generally considered non-mobile such as personal computers, servers, or the like.

Components of the mobile device 400 may include, but are not limited to, a processing unit 405, system memory 410, and a bus 415 that couples various system components including the system memory 410 to the processing unit 405. The bus 415 may include any of several types of bus structures including a memory bus, memory controller, a peripheral bus, and a local bus using any of a variety of bus architectures, and the like. The bus 415 allows data to be transmitted between various components of the mobile device 400.

The mobile device 400 may include a variety of computer-readable media. Computer-readable media can be any available media that can be accessed by the mobile device 400 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 400.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, WiFi, WiMAX, and other wireless media. Combinations of any of the above should also be included within the scope of computer-readable media.

The system memory 410 includes computer storage media in the form of volatile and/or nonvolatile memory and may include read only memory (ROM) and random access memory (RAM). On a mobile device such as a cell phone, operating system code 420 is sometimes included in ROM although, in other embodiments, this is not required. Similarly, application programs 425 are often placed in RAM although again, in other embodiments, application programs may be placed in ROM or in other computer-readable memory. The heap 430 provides memory for state associated with the operating system 420 and the application programs 425. For example, the operating system 420 and application programs 425 may store variables and data structures in the heap 430 during their operations.

The mobile device 400 may also include other removable/non-removable, volatile/nonvolatile memory. By way of example, FIG. 4 illustrates a flash card 435, a hard disk drive 436, and a memory stick 437. The hard disk drive 436 may be miniaturized to fit in a memory slot, for example. The mobile device 400 may interface with these types of non-volatile removable memory via a removable memory interface 431, or may be connected via a universal serial bus (USB), IEEE 4394, one or more of the wired port(s) 440, or antenna(s) 465. In these embodiments, the removable memory devices 435-137 may interface with the mobile device via the communications module(s) 432. In some embodiments, not all of these types of memory may be included on a single mobile device. In other embodiments, one or more of these and other types of removable memory may be included on a single mobile device.

In some embodiments, the hard disk drive 436 may be connected in such a way as to be more permanently attached to the mobile device 400. For example, the hard disk drive 436 may be connected to an interface such as parallel advanced technology attachment (PATA), serial advanced technology attachment (SATA) or otherwise, which may be connected to the bus 415. In such embodiments, removing the hard drive may involve removing a cover of the mobile device 400 and removing screws or other fasteners that connect the hard drive 436 to support structures within the mobile device 400.

The removable memory devices 435-437 and their associated computer storage media, discussed above and illustrated in FIG. 4, provide storage of computer-readable instructions, program modules, data structures, and other data for the mobile device 400. For example, the removable memory device or devices 435-437 may store images taken by the mobile device 400, voice recordings, contact information, programs, data for the programs and so forth.

A user may enter commands and information into the mobile device 400 through input devices such as a key pad 441 and the microphone 442. In some embodiments, the display 443 may be touch-sensitive screen and may allow a user to enter commands and information thereon. The key pad 441 and display 443 may be connected to the processing unit 405 through a user input interface 450 that is coupled to the bus 415, but may also be connected by other interface and bus structures, such as the communications module(s) 432 and wired port(s) 440.

A user may communicate with other users via speaking into the microphone 442 and via text messages that are entered on the key pad 441 or a touch sensitive display 443, for example. The audio unit 455 may provide electrical signals to drive the speaker 444 as well as receive and digitize audio signals received from the microphone 442.

The mobile device 400 may include a video unit 460 that provides signals to drive a camera 461. The video unit 460 may also receive images obtained by the camera 461 and provide these images to the processing unit 405 and/or memory included on the mobile device 400. The images obtained by the camera 461 may comprise video, one or more images that do not form a video, or some combination thereof.

The communication module(s) 432 may provide signals to and receive signals from one or more antenna(s) 465. One of the antenna(s) 465 may transmit and receive messages for a cell phone network. Another antenna may transmit and receive Bluetooth® messages. Yet another antenna (or a shared antenna) may transmit and receive network messages via a wireless Ethernet network standard.

In some embodiments, a single antenna may be used to transmit and/or receive messages for more than one type of network. For example, a single antenna may transmit and receive voice and packet messages.

When operated in a networked environment, the mobile device 400 may connect to one or more remote devices. The remote devices may include a personal computer, a server, a router, a network PC, a cell phone, a peer device or other common network node, and typically includes many or all of the elements described above relative to the mobile device 400.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-readable medium having computer-executable instructions, which when executed perform steps, comprising:
receiving a request to return a set of resources, in which the request is associated with a particular application program that is not a user-initiated search program;
traversing a hierarchical storage to enumerate resource items corresponding to the requested set of resources; and
returning a result set comprising one or more resource items arranged as a flat list in response to the request.

2. The computer-readable medium of claim 1 wherein the request is associated with a type of resource, and wherein traversing the hierarchical storage to enumerate the resource items comprises using the type of resource as a filtering criterion.

3. The computer-readable medium of claim 2 wherein the hierarchical storage corresponds to a file system, and wherein the type of resource comprises at least one file extension.

4. The computer-readable medium of claim 1 wherein the request is associated with a type of resource by providing type information as a set of one or more parameters.

5. The computer-readable medium of claim 1 wherein the request is associated with a type of resource by registering type information in association with an application program.

6. The computer-readable medium of claim 1 having further computer-executable instructions comprising caching the enumerated resource items.

7. The computer-readable medium of claim 1 having further computer-executable instructions comprising sorting or grouping, or both sorting and grouping, the enumerated resource items.

8. The computer-readable medium of claim 1 having further computer-executable instructions comprising, presenting the flat list for interactive selection.

9. In a computing environment, a system comprising:
a resource selector coupled to a hierarchical storage system; and
a trigger coupled to the resource selector that when activated, triggers the resource selector to traverse the hierarchical storage structure to enumerate resources and return a result set of one or more resource items as a flat list independent of each resource item's position in the hierarchical storage structure.

10. The system of claim 9 wherein the trigger is incorporated into an application program, and wherein the application program is associated with at least one filtering criterion by which the resource selector filters the resource item or items in the result set.

11. The system of claim 9 wherein the trigger comprises an application-independent component, and wherein when triggered, the resource selector enumerates resources based on an application program that currently has focus.

12. The system of claim 9 wherein the result set includes means for indicating a resource item as a selection candidate.

13. The system of claim 12 wherein the result set includes means for indicating a path corresponding to a position in the hierarchical storage structure of the selection candidate.

14. The system of claim 9 wherein the resource selector and trigger are incorporated into a handheld computing device.

15. The system of claim 9 further comprising a cache coupled to the resource selector for caching data corresponding to the result set.

16. In a computing environment, a method comprising:
enumerating resource items associated with an application program, the resource items representing resources arranged in a hierarchy; and
presenting a flat list of the resource items for user interaction therewith, including for selection of at least one resource item for access by the application program.

17. The method of claim 16 wherein presenting the flat list of the resource items for user interaction comprises, visibly indicating a candidate item for selection.

18. The method of claim 17 further comprising, indicating a path corresponding to a position in the hierarchy of the candidate item.

19. The method of claim 16 wherein enumerating the resource items associated with the application program comprises filtering files based upon an extension set of at least one file extension associated with the application program.

20. The method of claim 19 wherein filtering the files comprises receiving the extension set as a parameter, or looking up the extension set based upon the application program.
